(19) United States
(12) Patent Application Publication
(10) Pub. No.: US 2010/0277589 A1
(43) Pub. Date: Nov. 4, 2010

(54) Internal(inside) automobile side rearview mirrors for the rearview of left and right side of the vehicle mounted on the both sides of dash board, which are to replace the external(outside) side (rearview) mirrors mounted on the both sides of the front doors of the vehicle or on the body of the vehicle and thus minimize the risk of getting the side mirror being smashed/damaged by other passing by vehicle and maximize the side rearview for changing the lane and help avoid making the hazardous decision while driving

(76) Inventor: Seongtai Song, Flushing, NY (US)

Correspondence Address: Seongtai Song, 146 - 52 28th Ave. # 2F, Flushing, NY, 11354, US

(21) Appl. No.: 12/455,482

(22) Filed: Jun. 3, 2009

Related U.S. Application Data
(60) Provisional application No. 61/215,029, filed on May 1, 2009.

(51) Int. Cl. H04N 7/18

(52) U.S. Cl. 348/148; 348/E07.085

(57) ABSTRACT

Computerized internal side rearview mirrors showing the wider angle of both sides and rear of the vehicle with additional function of alerting the driver when trying to change the lane at the risk of accident.

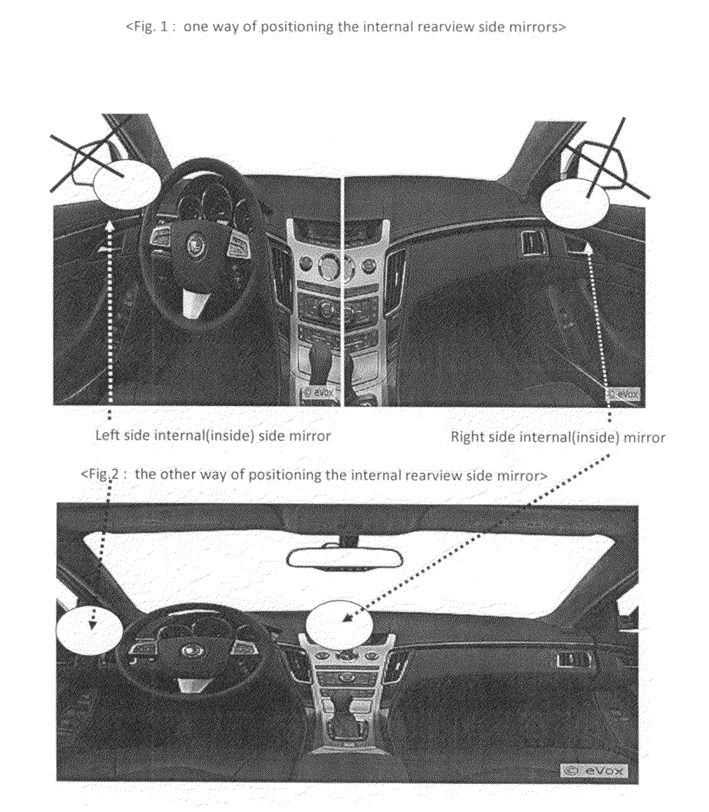

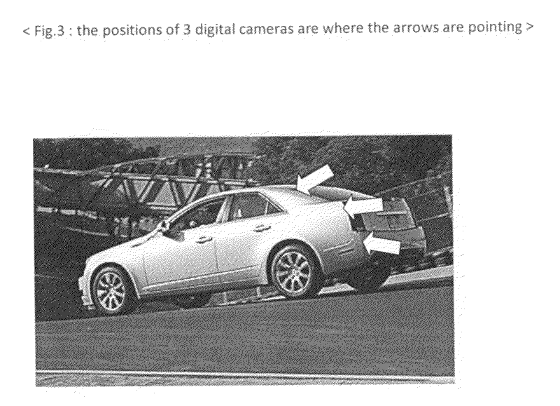

### REFERENCE TO SEQUENCE LISTING, A TABLE, OR COMPUTER PROGRAM LISTING

Not Applicable

### BACKGROUND OF INVENTION

Having witnessed myself so many damaged/broken external side rearview mirrors out of burglary or accidents resulted from passing the vehicle at the opposite direction or careless driving by other drivers while your car is parked unattended, I have been studying about how possibly the external side rearview mirrors can be removed and have them mounted at the safer position.

I myself experienced the burglary case. One morning about a couple of months ago, I found that someone had broken away the driver side of rearview mirror.

Besides, when I am driving at the narrow two way street in New York city, I feel very anxious about possible collision of both parties' external side view mirrors while passing each other.

### BRIEF SUMMARY OF THE INVENTION

These internal side rearview mirrors are actually the computer monitors that reflect the moving pictures taken from the digital cameras and processed through the computer software, of which working mechanism is as follows;
1. The built-in digital video cameras transmit the driving condition around both sides and rear of the vehicle.
2. The internally mounted computer processes the digitally transmitted pictures.
3. The computer monitors functioning as the internal side rearview mirrors are showing the real-time driving situation around the sides and rear of the vehicle just as the conventional external side rear view mirrors do.

### DETAILED DESCRIPTION OF THE INVENTION

The internal(inside) side mirrors are suitably downsized computer monitors showing the live real-time moving pictures of driving situation of the left, right and rear of the vehicle.
These internal(inside) side mirrors can be either built in on a fixed position or detachable for other position at driver's choice.
The size of these mirrors (computer monitors) are approximately 9-10 inches in horizontal length and 4-5 inches in vertical length.
These mirrors show the left and right side of rearview transmitted from the camera(s) and processed through the computer.
The internal built-in camera(s) are mounted in at least 3 separate positions on both rear edges of the vehicle. But only one camera is working at driver's choice at a time. The others are spare cameras in case of accident or malfunctioning.
The computer can be installed in any part of inside the dash board and can record and store the last 10 minutes of driving situation on both sides of the vehicle just in case the vehicle is involved in traffic accident. Also the computer alerts the driver when the vehicle is being approached by other vehicles when changing the lane by making the alarm sound.
The process of transmitting the rear view driving situation is as follows;
1. The camera transmits the moving pictures of driving situation of both left and right rear side to help driver make the decision when to change the lane through the cable connected to the computer.
2. The internal side mirrors(computer monitors) then displays the transmitted moving pictures through the computer.
3. The computer constantly calculates the distance between the two vehicles and alerts the driver when the other vehicle is approaching too close.
4. The driver can choose any of 3 cameras depending on the situation. When reversing the vehicle, the lower camera can be more helpful.

1. The internal(inside) side rearview mirrors for the vehicles (cars, trucks, buses, vans, minivans, SUVs, etc.) in the form of computer monitors that display the real-time moving pictures of both sides and rear, that are transmitted from digital video cameras mounted on the rear of the vehicle and processed through built-in computer.
